(19) United States
(12) Patent Application Publication
(10) Pub. No.: US 2004/0063446 A1
(43) Pub. Date: Apr. 1, 2004

(54) Communication apparatus and methods

(76) Inventor: Murray Valpy Kennett, Waitakere City (NZ)

Correspondence Address: YOUNG & THOMPSON, 745 SOUTH 23RD STREET 2ND FLOOR, ARLINGTON, VA, 22202

(21) Appl. No.: 10/463,405

(22) Filed: Jun. 18, 2003

(30) Foreign Application Priority Data
Jun. 18, 2002 (NZ) 519636

(51) Int. Cl. H04Q 7/20; H04M 1/00

(52) U.S. Cl. 455/466; 455/557

(57) ABSTRACT

The invention relates to a communications apparatus which includes an input/output transducer interface, a text message generation means connected to the interface to generate a text message dependent on an electrical signal input to the interface, or to decode a received text message for provision to the interface.

### FIELD OF THE INVENTION

This invention relates to communication devices and methods of communication. The invention has particular relevance to wireless communication systems and the use of short message service (SMS) text massaging.

### BACKGROUND OF THE INVENTION

SMS is well known as being used in mobile telephone communication networks to provide text messaging services. These are evolving and arc beginning to be extended to multimedia messaging services (MMS). In either context, users can use the services to transmit symbols which can be viewed on telephone displays to convey information to a user. In this document, reference to text messaging refers to the use of symbols or pictures as well as text i.e. includes MMS messaging as well as SMS messaging.

The symbols that are transmitted usually comprise a short Binge and many telephones only permit a maximum string length of approximately 150 characters, however the text messaging services are very popular, since frequently a large amount of information can be sent using a relatively short string of characters.

Wireless networks have the advantage that they provide a means of communication without any investment in physical apparatus such as transmission wires or the like. This makes these networks very convenient for communication between inconvenient locations, and for maintaining reliable communication links when users of the system arc often in a number of different locations.

There are many fields for which a simple wireless communications solution would be highly advantageous. These fields include agriculture security systems, and utilities organisations to name a few. Something that has prevented telephone communications networks being used effectively in these areas is complexity of the communications which are required to take place which leads to high costs for installing wireless communication systems.

### OBJECT OF THE INVENTION

It is an object of the present invention to provide an improved communications device, method or system, or to at least provide the public with a useful choice.

### SUMMARY OF THE INVENTION

Accordingly in one aspect the invention may broadly be said to consist in communications apparatus including

transducer interface, input/output

text message generation means operatively connected to the interface to

(a) generate a text message dependent on an electrical signal input to the interface, or

(b) decode a received text message for provision to the interface.

Preferably the interface is physically adapted to receive digital or analogue electrical signals, or to produce digital or analogue electrical signals dependent upon whether a text message is being generated or received.

Preferably the text generation means include processing means and wireless communication means.

In the preferred embodiment, the processing means process digital or analogue incoming signals from the transducer interface into an appropriate symbolic format for transmission by the wireless communication means.

Preferably the processing means also receive information from the wireless communication means and process or decode that information for provision to the transducer interface which can then provide an output electrical signal to operate a transducer.

Preferably the wireless communication means include a unique identifier on a communications network, such as a cellular or mobile telephone network.

Preferably the processing means or the wireless communication means includes a destination selection means to select a required destination for the output message, such as a telephone number on a mobile or cellular telephone network or server/ E-Mail address.

Preferably the transducer interface is connected to an input transducer and/or an output transducer.

By way of example, an input transducer may comprise a microswitch, a water level or pressure transducer, an alarm output, a PIR device or a temperature transducer.

By way of example an output transducer may include one or more of an electric motor, a light or LED, a solenoid, a siren or alarm system input, or a valve assembly.

In a further aspect the invention may broadly be said to consist in control or monitoring apparatus according to the preceding statement of invention.

In a further aspect the invention may broadly be said to consist in a method of communication comprising the steps of

providing a transducer interface,

providing a text message generation means operatively connected to the interface to

(c) generate a text message dependent on an electrical signal input to the interface, or

(d) decode a received text message for provision to the interface.

The invention also broadly consists in any features described herein that are new, either alone or in combination. Equivalents of any features that are not specifically disclosed are deemed to be included.

### DRAWING DESCRIPTION

The invention consists of the foregoing and also envisages constructions of which the following gives examples only.

One presently preferred embodiment of the invention will now be described with reference to the accompanying drawings, wherein;

FIG. 1 is a block diagram showing modules for a communication device according to the invention.

FIG. 2 is a diagrammatic overview of applications for the communication device of FIG. 1.

### DETAILED DESCRIPTION

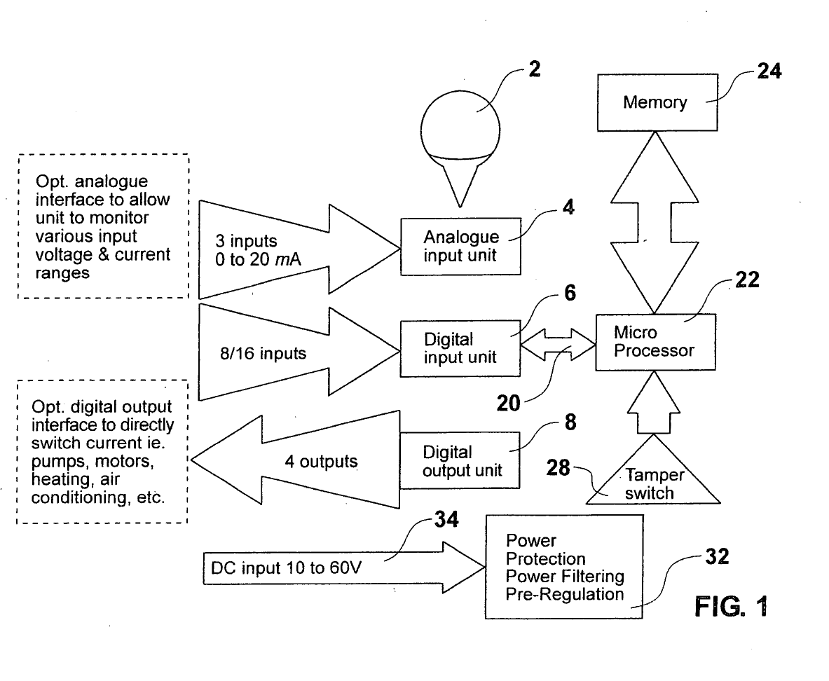

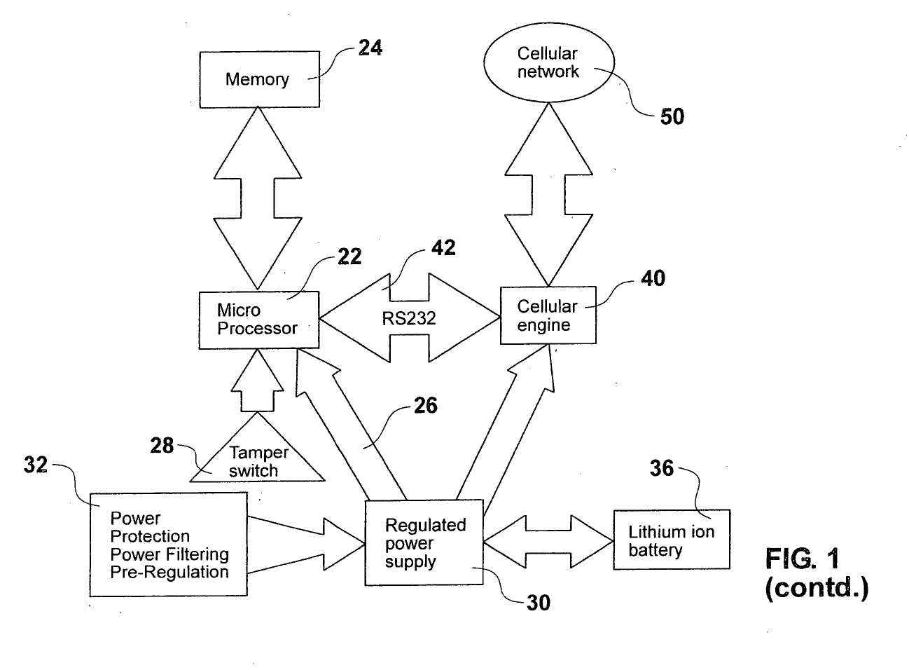

Referring to FIG. 1, a basic conceptual block diagram of various components that together constitute a communication device according to the invention are shown, The device has a transducer interface generally referenced 2 and his, in the preferred form, includes an. analogue input unit 4, a digital input unit 6 and a digital output unit 8. Although not shown in the drawing, an analogue output unit may also be provided.

The analogue input unit preferably has three physical inputs, each capable of accepting a current from zero to twenty miliamps. The digital input unit preferably has eight or sixteen inputs. The digital output unit 8 preferably has four physical output terminations for provision of the digit data.

Optionally, the analogue input may include a further interface to allow a variety of voltage and current ranges to be monitored and provided to the analogue input unit 4. For example, it may be preferable in some contexts to monitor a voltage (for example a mains voltage), or monitor a current which exceeds 20 milliamps. Thus an optional interface that provides a low current signal corresponding to the monitored voltage or current can be provided to produce an output from the interface into the analogue input unit

Similarly, the digital output interface may include a further optional interface to directly switch current This may be particularly desirable in applications such as switching pumps, motors, heaters, air conditioning units and the like.

The input interface 2 is connected by a suitable bus 20 to a microprocessor 22 which typically includes memory 24 and a power supply connection 26.

A tamper switch 28 provides an indication as to whether any unauthorised physical access to the device has occurred.

The power supply input 26 is derived from a regulated power supply unit 30 which is supplied from a DC input 34 of preferably 10 to 60 volts, which is filtered and pre-regulated by unit 32. As the backup supply, a battery, such as a lithium ion battery 36 is also provided.

The regulated power supply 30 also supplies cellular engine 40. Communication between the cellular engine and microprocessor occurs via an RS232 protocol represented by reference numeral 42.

The cellular engine 40 is able to communicate with an appropriate cellular telephone network 50.

The device of FIG. 1 operates as follows. The digital input unit 6 may be connected, for example, to a PIR detector, which provides a digital signal output when it is activated. Therefore, if the PIR detects movement such as movement in a certain area of the building or outside a building, the output is provided to the digital input unit 6 which provides an appropriate signal to bus 20 to be provided to the microprocessor 22. From the signal received, the microprocessor knows what the signal relates to i.e. to the PIR detector being activated The, microprocessor can then use software resident in memory 24, which may include a suitable lookup table for example to produce an output message corresponding to the input signal. In this instance the message may be, for example, “alarm-room 1”. This text message from memory can be output in an appropriate digital format across RS232 link, 42 to the cellular engine 40. The cellular engine then operates in known way with cellular telephone technology to transmit the text message to a certain desired destination number or numbers.

The desired destination or destinations may lead to a user's mobile telephone for example, or could be to a server or an email address A combination of these could also be the recipient. In this way, a user of the system is alerted almost instantaneously to a problem occurring. In this example, the PIR detector may be mounted in the vicinity of a driveway or some out-building in a rural environment, A farmer having a mobile phone which receives the message would know that his or her attention was required in the vicinity in which the PIR detector was mounted.

It will be seen that other inputs may be provided to the analogue, input unit, and still more inputs may be provided to the digital input unit 6 The microprocessor can discriminate, based upon the input provided from the transducer interface 2, which inputs correspond to various conditions, and can use the lookup tables from memory 24 to provide appropriate messages.

The device shown in FIG. 1 can also receive messages having text or other symbolic formats. Therefore, although reference is made throughout this document to SMS text messaging, the invention also envisages using multimedia messaging services so hat messages can be sent using a variety of pictures or symbols as well as text characters.

The transducer interface 2 can also provide output signals from the digital output unit 8 (and/or an appropriate analogue output unit if desired). Therefore, the cellular engine 40 has a particular unique identifier, such as a telephone number on a cellular network. Therefore, the cellular engine can receive tart messages from a network 50. The messages that are received are passed over the RS232 connection 42 to the microprocessor 22 where they can be decoded, again using software resident in memory 24, so that an appropriate output signal can be placed on bus 20 for digital output unit 8. To provide a more specific example, the digital output unit 8 may have an output which is connected to an electric motor control unit, the motor being operably connected to a water pump. If the user has received information (for example originating from the device of FIG. 1) that it would be desirable to operate the pump (for example to top up a reservoir), then the user can use a communications device such as a mobile phone, or computer via the internet or other network connection to send an appropriate command. In this instance the command could be for example the text message “ON P1” which may stand for turn on pump 1. The text message is sent to a telephone number corresponding to the device 1. In a preferred form of the invention, the telephone number will he stored in a user's mobile phone or personal computer having a descriptive name such as reservoir 1.

Once the text message is received by the cellular engine, it is passed to microprocessor 22, which uses software resident memory 24 to “decode” the message by matching the message with a required digital output which is provided to the digital output unit 2. It will be appreciated that, depending upon the microprocessor used, the analogue and digital input or output units may comprise part of the microprocessor.

The digital output is provided to the pump controller, which in this instance would operate the pump until such time as the level of the reservoir has been restored.

There are a variety of applications for which the device is suitable. The general features of the unit are set forth below:

Hardware:

Weather proof housing with mounts

Cellular module (Siemens TC35 GSM module for prototype)

Microprocessor cct.

Input module 8/16 digital inputs

Input module 3×0-20 mA analogue inputs.

Input protection for all inputs.

Output unit 4× digital ie: sets of contacts.

Optional analogue outputs.

Power filtering

Voltage Regulator

Power supply voltage monitor cct

Internal lithium ion battery

External antenna connector

Tamper switch

Analogue input interface for particular application, (optional extra)

Output interface for particular application, (optional extra)

Power Source:

Any DC. Power source between 10V and 60V.

Battery

AC to DC adaptor

Solar system

Wind System

Vehicle System

Remote Setup:

The unit can be set up & controlled by any PC. Using a modem or cellular modem in conduction with a communications package it may also be set up by direct connection of PC using the same ST) communications package such as hyperterminal.

The unit auto answers incoming calls with its cellular modem. It then prompts for a password. When entered correctly they then have access to a simple menu system that allows full control and setup of the unit.

Menu: (proposed example)

1. Read input status

2. Control outputs

3. Dialling list

4. Text messages for each input state

5. Prioratised dialling on/off

6. Prioratised dialling delay xx xx Min sec.

7. Status message text

8. Status message timing DD:HH:MM:SS

9. Rx. Text prompt message for input status Text report

10. Rx. Text prompt message for input deactivate

11. Rx. Text prompt message for input activate

12. Rx. Text prompt message for each output on/off

13. Tamper switch on/off

14. Change Password

15. Read battery voltage

16. Set analogue input units/scale

17. Set analogue inputs alarm trigger points.

Monitoring/Alarm reception:

Any Text capable cell phone.

Any PC. Or server with text capable cellular modem

Any WWW e-mail address

Any WWW mail server

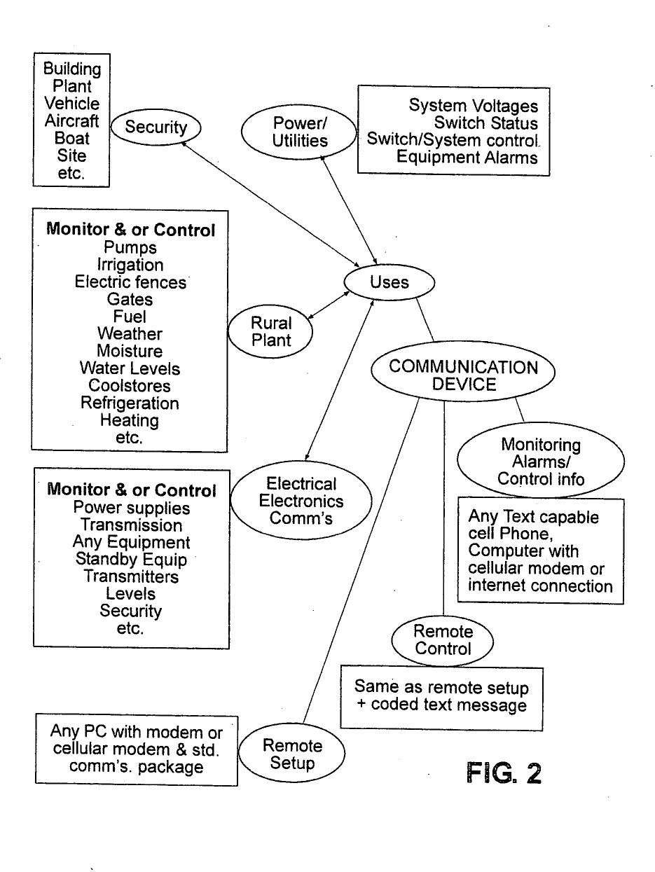

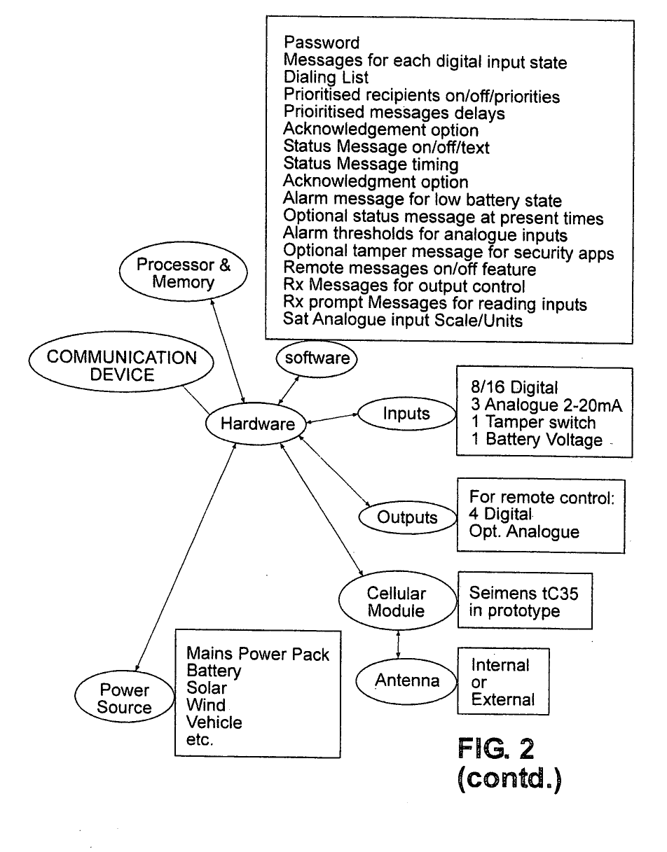

Turning now to FIG. 2, an overall schematic that includes examples of programming and operation of the unit is provided. The FIGURE is largely self-descriptive, but a short explanation of the programming aspect is provided below.

As can be seen from the “software” branch in FIG. 2, a user of the system is provided with a menu which is accessible using a password. This can be used by the user to program the apparatus. It will be appreciated that programming may take place proximate to the unit, or at a remote location using a cellular network as the communication medium. In the most preferred form the menu is provided to a user accessing the relevant programming information in the unit over tie cellular network to the microprocessor 22.

Once the menu for programming has been accessed, messages can be assigned to each digital input state and established for the required output states. A dialling list can be established, and an acknowledgement option can be programmed as well, so that text commands which are sent to the device of FIG. 1 are acknowledged when the command has been processed. Users also preferably have the option of an alarm message for a low battery state or power failure of the device, and optional status messages at various times which may be present by the user. The alarm thresholds for analogue inputs can also be established, for example inputs less than two or three milliamps may not be recognised. Activation of the tamper switch 28 can be programmed, to provide an alarm to a user if desired. Finally, the apparatus can be programmed so as to be remotely activated or deactivated by relevant text commands.

There are a very wide variety of applications for the device, a number of which are listed below by way of example.

Alarm & Control Applications

The unit is capable of any of the following applications & or combinations of them.

Farming

Remote monitoring of outbuildings security. When door is opened, PIR detects movement or burglar alarm goes off a text message is generated & sent to a recipient, Group of recipients, A server or a E-mail address or combination of the above.

Remote monitoring of gates. When monitored gates are opened or closed a text message is generated & sent to a recipient Group of recipients, A server or a E-mail address or combination of the above.

Remote control of gates or doors. When a coded text message is sent to the unit or it is dialled tip the unit operates contacts to open/close, look/unlock the door or gate. Then texts back confirmation when it is done.

Remote monitoring of electric fences. When the fence voltage drops below a preset level a text message is generated & sent to a recipient, Group of recipients, A server or a E-mail address or combination of the above.

Remote control of electric fences. When a coded text message is sent to the unit or it is dialled up the unit operates contacts to Turn on/off the fence or sections of fence. Then texts back confirmation when it is done.

Remote monitoring of stock water schemes. When water pressure drops below preset pressure a text message is generated & sent to a recipient Group of recipients, A server or a E-mail address or combination of the above.

Remote monitoring of water tanks water level, input supply etc. & when levels go out of set tolerance a text message is generated & sent to a recipient, Group of recipients, A server or a E-mail address or combination of the above.

Remote control of stock water schemes. Remotely turn water or pumps on/off. When a coded text message is sent to the unit or it is dialled up the unit operates contacts to Turn on/off the water or pumps. Then texts back confirmation when it is done.

Remote monitoring of flood irrigation. When a loss of water is detected or when water reaches a detector a text message is generated & sent to a recipient, Group of recipients, A server or a E-mail address or combination of the above.

Remote control of flood irrigation. Operate gate/shutter ete. When a coded text message is sent to tie unit or it is dialled up the unit operates contacts to control the gates/shutters. Then texts back confirmation when it is done.

A Remote monitoring of water levels in dams & or races. When float or other switch operates or preset levels are exceeded a text message is generated & sent to a recipient, Group of recipients, A server or a E-mail address or combination of the above.

Remote monitoring of irrigation pumps & when pump stops, output pressure drops, input suction is lost, supply level drops etc. a text message is generated & sent to a recipient, Group of recipients, A server or a E-mail address or combination of the above.

Remote monitoring of climatic conditions such as frost, rainfall, temperature etc. & when preset parameters are exceeded a text message is generated & sent to a recipient Group of recipients, A server or a E-mail address or combination of the above.

Remote monitoring of glasshouses temperature, Humidity, Security etc. and when preset parameters are exceeded a text message is generated & sent to a recipient, Group of recipients, A server or a Thiail address or combination of the above.

Remote control of glasshouse heating & or ventilation. When a coded text message is sent to the unit or it is dialled up the unit operates contacts to turn heating/ventilation on or off. It then texts back confirmation when it is done.

Remote monitoring of cool stores/Refrigeration plant security equipment & temperatures. When preset parameters are exceeded a text message is generated & sent to a recipient Group of recipients, A server or a E-mail address or combination of the above.

Remote monitoring of stock shelters, Security, Feed, Water & or temperature & When preset parameters are exceeded a text message is generated & sent to a recipient, Group of recipients, A server or a E-mail address or combination of the above.

Remote monitoring of irrigators & when water pressure drops, they stop or run finishes a text message is generated & sent to a recipient Group of recipients, A server or a E-mail address or combination of the above

Remote monitoring of hydroponic systems and when pumps fail, moisture levels drop etc. a text message is generated & sent to a recipient, Group of recipients, A server or a E-mail address or combination of the above.

Remote control of hydroponic system pumps etc. Remotely start/stop pumps backup systems etc. When a coded text message is sent to the unit or it is dialled up the unit operates contacts to turn pumps etc. on/off. It then texts back confirmation when it is done.

Remote monitoring of cow shed security, power & systems and when parameters are exceeded a text message is generated & sent to a recipient, Group of recipients, A server or a E-mail address or combination of the above.

Remote monitoring of water levels to detect & predict flooding. When levels exceed preset parameters a text message is generated & seat to a recipient, Group of recipients, A server or a E-mail address or combination of the above.

Remote monitoring of water/Fluid levels and at preset times or when prompted or preset levels are exceeded a text message is generated & sent to a recipient, Group of recipients, A server or a E-mail address or combination of the above.

Remote monitoring of ground conditions such as soil moisture etc. and when preset levels are exceeded a text message is generated & sent to a recipient, Group of recipients, A server or a E-mail address or combination of the above.

Remote monitoring of fuel tanks & other storage tanks and bins. When parameters are exceeded a text message is generated & sent to a recipient Group of recipients, A server or a E-mail address or combination of the above.

Marine

Remote monitoring of boat security. When door is opened, PIR detects movement or burglar alarm goes off a text message is generated & sent to a recipient Group of recipients, A server or a E-mail address or combination of the above.

Remote monitoring of bilge water levels and when preset levels are exceeded a text message is generated & sent to a recipient, Group of recipients, A server or a E-mail address or combination of the above.

Remote monitoring of bilge pumps. When pump fails, starts, stops etc. a text message is generated & sent to a recipient Group of recipients, A server or a E-mail address or combination of the above.

Remote monitoring of Boat batteries, Mooring lights etc. when preset parameters are exceeded a text message is generated & sent to a recipient Group of recipients, A server or a E-mail address or combination of the above.

Remote monitoring of fire alarms & systems. When preset parameters are exceeded a text message is generated & sent to a recipient Group of recipients, A server or a E-mail address or combination of the above.

Remote monitoring of Gas buildup from Gas or fuel leaks etc. When preset parameters are exceeded a text message is generated & sent to a recipient, Group of recipients, A server or a E-mail address or combination of the above.

Remote monitoring of shore power. When power fails a text message is generated & sent to a recipient Group of recipients, A server or a E-mail address or combination of the above.

Remote monitoring of onboard systems, electronics, refrigeration etc. When a alarm occurs a text message is generated & sent to a recipient, Group of recipients, A server or a E-mail address or combination of the above.

Remote control of Generators & other systems. When a correctly coded message is received the appropriate equipment is switched on/off.

Power authority

Remotely monitor power lies, transformers etc, with either alarm inputs to the unit or analogue inputs to the unit. Monitoring line conditions and when digital input is operated/released or analogue input exceeds preset parameters a text message is generated & sent to a recipient, Group of recipients, A server or a E-mail address or combination of the above.

Remote monitoring of power levels and at preset times or when prompted or preset levels are exceeded a text message is generated & seat to a recipient Group of recipients, A server or a E-mail address or combination of the above.

Remotely monitor the state of fuses, switches, breakers etc. When the state of the monitored component changes a text message is generated & sent to a recipient Group of recipients, A server or a E-mail address or combination of the above.

Remotely control resets, switches, relays etc. When a coded text message is sent to the unit or it is dialled up the unit operates contacts to turn the above on/off. It then texts back confirmation when it is done.

Remotely Monitor substation/cabinet security. When door is opened, PIR detects movement or burglar alarm goes off a text message is generated & sent to a recipient, Group of recipients, A server or a E-mail address or combination of the above.

Water Authorities/Utilities

Remotely monitor water levels in tanks, dams, rivers and streams etc. With either alarm inputs to the unit or analogue inputs to the unit. Monitoring water levels. When digital input is operated/released or analogue input exceeds preset parameters or unit is prompted a text message is generated & sent to a recipient, Group of recipients, A server or a E-mail address or combination of the above.

Remotely monitor water pressures in pipelines etc. With either alarm inputs to the unit or analogue inputs to the unit. Monitoring water pressures. When digital input is operated/released or analogue input exceeds preset parameters or unit is prompted a text message is generated & sent to a recipient, Group of recipients, A server or a E-mail address or combination of the above.

Remotely monitor pumps, filters etc. With either alarm inputs to the unit or analogue inputs to the unit. Monitoring water pressures, overload switches, temperatures, power etc. When digital input is operated/released or analogue input exceeds preset parameters or unit is prompted a text message is generated & sent to a recipient, Group of recipients, A server or a E-mail address or combination of the above.

Remotely monitor Sewerage, Stormwater etc. With either alarm inputs to the unit or analogue inputs to the unit. Monitoring water pressures, levels, pumps, filters etc. When digital input is operated/released or analogue input exceeds preset parameters or unit is prompted a text message is generated & sent to a recipient, Group of recipients, A server or a E-mail address or combination of the above.

Remotely monitor for gas leaks/buildup etc. at preset times or when prompted or preset levels are exceeded a text message is generated & sent to a recipient, Group of recipients, A server or a E-mail address or combination of the above.

Remotely control pumps, Valves etc. using the unit's outputs. When a coded text message is sent to the unit or it is dialled up the unit operates contacts to turn the above on/off. It the texts back confirmation when it is done.

Remotely monitor Pumphouse security. When door is opened, PIR detects movement or burglar alarms goes off a text message is generated & sent to a recipient, Group of recipients, A server or a E-mail address or combination of the above.

Telecommunications

Remote monitoring of equipment alarms. When one or more alarm inputs state changes a text message is generated & seat to a recipient, Group of recipients, A server or a E-mail address or combination of the above.

Remote monitoring of equipment power supplies AC & DC either by digital alarm inputs or analogue inputs. When digital input is operated/released or analogue input exceeds preset parameters, Preset time is reached or unit is prompted. A text message is generated & sent to a recipient, Group of recipients, A server or a E-mail address or combination of the above.

Remotely monitor site, cabinets, security, temperature, heating, air conditioning and or ventilation. When preset parameters are exceeded a text message is generated & sent to a recipient, Group of recipients, A server or a E-mail address or combination of the above.

Remotely monitor Receiver AGC's. With the analogue inputs. When a analogue input exceeds preset parameters or unit is prompted or at pre determined intervals a text message is generated & sent to a recipient Group of recipients, A server or a E-mail address or combination of the above.

Remotely Monitor transmit power & or VSWR. With the analogue inputs. When a analogue input exceeds preset parameters or unit is prompted or at pre determined intervals a text message is generated & sent to a recipient, Group of recipients, A server or a E-mail address or combination of the above.

Remotely monitor standby power plant and batteries using both digital & or analogue inputs. When digital input is operated/released or analogue input exceeds preset parameters. Preset time is reached or unit is prompted. A text message is generated & sent to, a recipient, Group of recipients, A server or a E-mail address or combination of the above.

Remotely control equipment such as standby power plant, Transmitters, Receivers, Bearer paths, Standby equipment etc. utilising the unit's outputs. When a coded text message is sent to the unit or it is dialled up the unit operates contacts to turn the above on/off. It then texts back confirmation when it is done.

Aviation

Remotely monitor hanger, aircraft & or fuel tank security with the unit. When alarm is triggered a text message is generated & sent to a recipient, Group of recipients, A server or a E-mail address or combination of the above.

Contractors

Remotely monitor site security. When alarm is triggered a text message is generated & sent to a recipient, Group of recipients, A server or a E-mail address or combination of the above.

Remotely monitor drainage pumps etc, When alarm is triggered a text message is generated & sent to a recipient Group of recipients, A server or a E-mail address or combination of the above.

Remotely monitor water levels or for water ingress. When detected a text message is generated & sent to a recipient, Group of recipients, A server or a E-mail address or combination of the above.

Remotely monitor site power and when power is lost. A text message is generated & sent to a recipient, Group of recipients, A server or a E-mail address or combination of the above.

Remotely monitor mobile and other plant. When a alarm is caused a text message is generated & sent to a recipient, Group of recipients, A server or a E-mail address or combination of the above.

Remotely control pumps, generators etc. Receipt of a correctly coded message switches on/off equipment/plant and acknowledges that it is done.

Skifields

Remotely monitor chairlifts, security, power fluid levels & alarms. When preset parameters are exceeded a text message is generated & sent to a recipient, Group of recipients, A server or a E-mail address or combination of the above.

Remotely monitor building security. When a alarm occurs a text message is generated & sent to a recipient, Group of recipients, A server or a E-mail address or combination of the above.

Remotely monitor building services such as power, water, heating, air conditioning etc. and when a alarm is detected a text message is generated & sent to a recipient, Group of recipients, A server or a E-mail address or combination of the above.

Remotely warn ski patrol etc. When alarm button is pushed a text message is generated & sent to a recipient, Group of recipients, A server or a E-mail address or combination of the above.

Remotely control backup system & or plant. When a correctly coded message is received the unit switches the designated output on/off controlling the attached equipment. It then acknowledges that it has done so.

Traffic Control

Remotely monitor Traffic signals. When power is lost, cabinet door opened or system failure etc. generates an alarm. A text message is generated & sent to a recipient, Group of recipients, A server or a E-mail address or combination of the above.

Remotely control/reset traffic control systems. When a coded text message is sent the unit or it is dialled up the unit operates contacts to initiate a reset, shutdown etc. It then texts back confirmation when it is done.

Remotely monitor Traffic counters. The digital inputs are used to monitor a binary counter. At preset times or when prompted the unit return's a text message of the input states which indicates the binary count. As with alarms which is sent as a text message to a recipient, Group of recipients, A server or a E-mail address or combination of the above.

Remotely reset traffic counters. When a coded text message is sent to the unit or it is dialled up the unit operates contacts to initiate a reset It then texts back confirmation when it is done.

Home/Holiday home/business

Remotely monitor security system is independent of phone lines. When door is opened, PIR detects movement or burglar alarm goes off a text message is generated & sent to a recipient, Group of recipients, A server or a E-mail address or combination of the above.

Remotely monitor security systems in places where there is no phone line or it is not economic to have one. Examples are warehousing, cool stores, dangerous goods stores, storage facilities etc. When door is opened, PIR detects movement or burglar alarm goes off, Fire alarm is activated etc. A text message is generated & sent to a recipient, Group of recipients, A server or a E-mail address or combination of the above.

Remotely monitor mains power, refrigeration etc. On failure & restoration a text message is generated & sent to a recipient, Group of recipients, A server or a E-mail address or combination of the above.

Remotely control such things as heating, Water heating, Airconditioning etc. When a correctly coded message is received the designated output switches activating or deactivating the attached equipment then acknowledges that it has done so.

Factories

Remotely monitor security & other building alarms. When alarm is triggered a text message is generated & sent to a recipient, Group of recipients, A server or a E-mail address or combination of the above.

Remotely monitor process control. When alarm is triggered a text message is generated & sent to a recipient, Group of recipients, A server or a E-mail address or combination of the above.

Remotely control processes and backup systems etc. When a correctly coded message is received the designated output switches activating or deactivating the attached equipment the acknowledges that it has done so.

Throughout the description and claims of this specification the word “comprise” and variations of that word, such as “comprises” and “comprising”, are not intended to exclude other additives, components, integers or steps.

1. A communications apparatus including
a transducer interface, input/output
a text message generation means operatively connected to the interface to
(a) generate a text message dependent on an electrical signal input to the interface, or
(b) decode a received text message for provision to the interface.

2. The interface as claimed in claim 1, is physically adapted to receive digital or analogue electrical signals, or to produce digital or analogue electrical signals dependent upon whether a text message is being generated or received.

3. The text generation means as claimed in claim 1, include processing means and wireless communication means.

4. A processing means process digital or analogue incoming signals from the transducer interface into an appropriate symbolic format for transmission by the wireless communication means.

5. The processing means as claimed in claim 4, also receive information from the wireless communication means and process or decode that information for provision to the transducer interface which can then provide an output electrical signal to operate a transducer.

6. The wireless communication means as claimed in claim 4, include a unique identifier on a communications network, such as a cellular or mobile telephone network.

7. The processing means or the wireless communication means as claimed in claim 4, includes a destination selection means to select a required destination for the output message, such as a telephone number on a mobile or cellular telephone network or server/E-mail address.

8. The transducer interface as claimed in claim 4, is connected to an input transducer and/or output transducer.

9. An input transducer comprising a microswitch, a water level or pressure transducer, an alarm output, a PIR device or a temperature transducer.

10. An output transducer including one or more of an electric motor, a light or LED, a solenoid, a siren or alarm system input, or a valve assembly.

11. A control or monitoring apparatus according to any of the preceding claims.

12. A method of communication comprising the steps of
providing a transducer interface,
providing a text message generation means operatively connected to the interface to
(c) generate a text message dependent on an electrical signal input to the interface, or
(d) decode a received text message for provision to the interface.
